(19) United States
(12) Patent Application Publication
(10) Pub. No.: US 2025/0044193 A1
(43) Pub. Date: Feb. 6, 2025

(54) SYSTEM AND METHOD FOR DETERMINING BEARING PRELOAD BY FREQUENCY MEASUREMENT

(71) Applicant: Aktiebolaget SKF, Göteborg (SE)

(72) Inventors: John Cardwell, III, Harleysville, PA (US); Martin D Rhodus, Camden, SC (US)

(21) Appl. No.: 18/796,861

(22) Filed: Aug. 7, 2024

Related U.S. Application Data
(63) Continuation-in-part of application No. 17/562,102, filed on Dec. 27, 2021, now abandoned.

(51) Int. Cl. G01M 13/045

(52) U.S. Cl. CPC G01M 13/045

(57) ABSTRACT

A method of determining bearing preload by frequency measurement, the method including the steps of: providing a machine assembly including a bearing, a plurality of sensors in communication with the machine assembly, and a processor in communication with the plurality of sensors, measuring the following related frequencies of the machine assembly including the bearing with the processor, a noise floor energy, a broadband energy, enveloping harmonics, and an overall vibration energy, obtaining a numerical relationship by spectral analysis for each of the related frequencies and storing them into a memory, comparing the numerical relationship stored in memory for each of the related frequencies to a predetermined baseline value. A match between the numerical relationship for each of the stored frequency and the predetermined baseline value indicates a correct preload has been determined. Also, a system for carrying out the method.

### CROSS-REFERENCE TO RELATED APPLICATIONS

This application claims priority to and benefit of U.S. Patent Application 17/562,102, filed Dec. 27, 2021, which is hereby incorporated by reference in its entirety as if fully set forth herein.

### TECHNOLOGICAL FIELD

This invention relates to a system and method of determining bearing preload by frequency measurement. More particularly, this invention relates to a system and method of determining bearing preload by frequency measurement that includes an assembly including a bearing having an inner ring, an outer ring, and a plurality of rolling elements mounted to a machine.

### BACKGROUND OF THE INVENTION

Measuring preload in large bearings during manufacture can be difficult. Measuring the preload state of many bearing sizes and styles during operation can also be difficult. The main reason for wanting to be in a preload state is to prevent rolling elements skidding and sliding and therefore damage to the raceways in operation. Having the ability to detect a looseness or non-preloaded state benefits bearing life.

Therefore, a lack of looseness (Radial Internal Clearance) can be detrimental to some Bearing designs and systems leading to a thermal runaway condition. Looseness in manufacture of bearings that are difficult to measure pre-load had been detected by ear, torque, and lift tests. Larger, thinner cross section bearings are often difficult to get a true physical measurement of clearance or preload due to their relative flexibility.

The ideas of what looseness looks like in bearings exists in the vibration industry as a generality, but these indicators have not been tied together as a tool or technique specifically in a manufacturing or performance viewpoint. Consequently, the present invention provides the ability that enables one to detect a looseness or a clearance state in order to insure reliable bearing performance prior at a manufacturing level.

### SUMMARY OF THE INVENTION

According to a first aspect, an exemplary embodiment relates to a method of determining bearing preload by frequency measurement, the method comprising the steps of: providing a machine assembly including a bearing, a plurality of sensors in communication with the machine assembly, and a processor in communication with the plurality of sensors, measuring the following related frequencies of the machine assembly including the bearing with the processor; a noise floor energy, a broadband energy, enveloping harmonics, and an overall vibration energy, obtaining a numerical relationship by spectral analysis for each of the related frequencies and storing them into a memory, comparing the numerical relationship stored in memory for each of the related frequencies to a predetermined baseline value, wherein a match between the numerical relationship for each of the stored frequency and the predetermined baseline value indicates a correct preload has been determined.

According to a second aspect, a system for determining bearing preload by frequency measurement, the system comprises: a machine assembly including a bearing, a plurality of sensors in communication with the machine assembly, a processor in communication with the plurality of sensors, wherein frequencies of the machine assembly including the bearing are measured with the processor, which include a noise floor energy, a broadband energy, enveloping harmonics, and an overall vibration energy, a numerical relationship for each of the related frequencies is obtained by the processor through spectral analysis, wherein the numerical relationship for each of the related frequencies is compared to a predetermined baseline value by the processor, and wherein a match between the numerical relationship for each of the related frequency and predetermined baseline value indicates a correct preload has been determined by the processor.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. It is understood, however, that the invention is not limited to the precise arrangements and instrumentalities shown. In the drawings:

FIG. 1 is a schematic view of a system for determining bearing preload by vibration measurement according to a first embodiment of the present invention;

FIG. 2 is a graph of frequency versus amplitude according to the system of FIG. 1;

FIG. 3 shows the method steps for carrying out the function of the system according to the embodiment of FIG. 1;

FIG. 4 is a cross-sectional view of the bearing 15 according to the system 100;

FIG. 5 is a graph illustrating an example of system 100 and the analysis for determining a numerical relationship between for frequencies;

FIG. 6 is a graph illustrating an exemplary plot with equation representing the ratio “interesting” (I) frequencies to “non-interesting” (N) frequencies; and

FIG. 7 is a graph illustrating a bearing operating under an ideal load.

### DETAILED DESCRIPTION OF THE INVENTION

Certain terminology is used in the following description for convenience only and is not limiting. The words “right,” “left,” “up,” and “down” designate the directions as they would be understood by a person facing in the viewing direction unless specified otherwise. At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. The words “outer” and “inner” refer to directions away from and toward, respectively, the geometric center of the specified element, or, if no part is specified, the geometric center of the invention. The terms “downward” and “upward refers to directions above and below the referenced component, respectively, unless specified otherwise. Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty) (20° degrees, provides specific literal support for any angle greater than twenty) (20° degrees, such as twenty-three) (23° degrees, thirty) (30° degrees, thirty-three-point five) (33.5° degrees, forty-five) (45° degrees, fifty-two) (52° degrees, or the like and thus provides support for claiming a preferred embodiment with the element moving along the arcuate path thirty-three-point five) (33.5° degrees. The language “at least one of ‘A’, ‘B’, and ‘C’,” as used in the claims and in corresponding portions of the specification, means “any group having at least one ‘A’; or any group having at least one ‘B’; or any group having at least one ‘C’;—and does require that a group have at least one of each of ‘A’, ‘B’, and ‘C’.” More specifically, the language ‘at least two/three of the following list’ (the list itemizing items ‘1’, ‘2’, ‘3’, ‘4’, etc.), as used in the claims, means at least two/three total items selected from the list and does not mean two/three of each item in the list. The term “interior”, as used in the claims and corresponding portions of the specification means the area proximate to the center of the invention. The term “exterior” similarly defines the area not in proximity to the center of the invention. Additionally, the words “a” and “one” are defined as including one or more of the referenced items unless specifically stated otherwise. The terminology includes the words specifically mentioned above, derivatives thereof, and words of similar import.

A preferred implementation of the preferred method of the present invention will be described below (alone or in combination with various embodiments of the system 100). The steps of the method of the present invention can be performed in any order, omitted, or combined without departing from the scope of the present invention. As such, optional or required steps described in conjunction with one implementation of the method can also be used with another implementation or omitted altogether. Additionally, unless otherwise stated, similar structure or functions described in conjunction with the below method preferably, but not necessarily, operate in a generally similar manner to that described elsewhere in this application.

### System

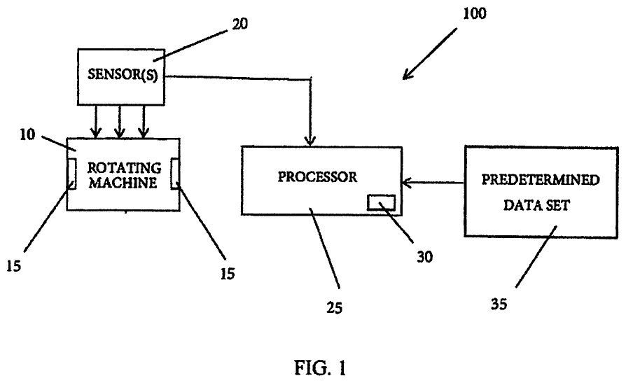

A system 100 for determining bearing pre load by frequency measurement is illustrated in FIG. 1. The system 100 provides a rotating machine assembly 10 that provides a bearing 15. Here, the rotating machine assembly 10 is a simple motor assembly 10 that includes two bearings 15. In addition, the system provides at least one sensor 20 that is communication with the rotating machine assembly 10. The at least one sensor may provide one of a laser vibrometer, an accelerometer and/or a coil vibrometer.

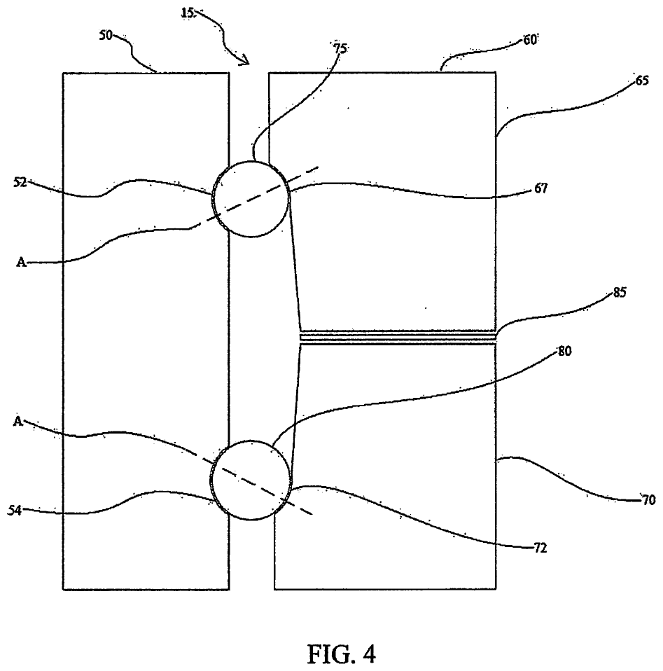

The bearing 15 may be seen in greater detail in FIG. 4. The bearing may comprise an outer ring 50, an inner ring 60, a first row of rolling elements 75, and a second row of rolling elements 80. The inner ring 60 may further comprise a first inner ring portion 65 and a second inner ring portion 70. The outer ring 50 may form first and second outer raceways 52, 54 to accommodate the first and second rows of rolling elements 75, 80, respectively. The first inner ring portion 65 may form a first inner raceway 67 accommodate the first row of rolling elements 75. The second inner ring portion 70 may form a second inner raceway 72 accommodate the first row of rolling elements 80. Here, the angular contacts A between the rows of rolling elements 75, 80 and the raceways 52, 54, 67, 72 may also be seen. The angular contacts A may vary with the width of the shim 85.

In the exemplary bearing shown in FIG. 4, the first inner ring portion 65 and the second inner ring portion 70 may be separated by a shim 85 axially therebetween. The angular contacts A may vary with the width of the shim 85. The shim 85 may be used for testing various loads on the bearing 15 to demonstrate how bearing defects may be detected through the system 100.

The system 100 also provides a processor 25 that is in communication with the at least one sensor 20. Data comprising the frequencies or vibrational energy of the rotating machine assembly 10 including the at least one bearing 15 are communicated to the processor 25. Here, the vibrational energy is measured, and the values are stored in a memory 30 within the processor 25.

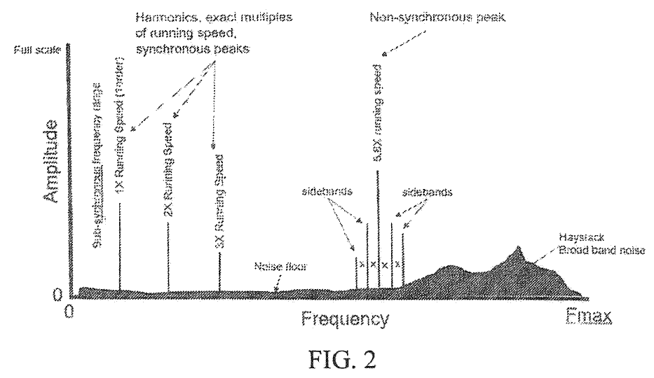

The vibrational energy that is contemplated by the present invention may include a noise floor energy, a broadband energy (Haystack), enveloping harmonics, and an overall vibration energy. See also FIG. 2 that illustrates a graph of frequency versus amplitude according to the system. A numerical relationship for each of the frequencies is obtained by the processor through spectral analysis. Each of the numerical relationships are stored within a memory 30 contained within the processor 25.

The numerical relationship for each of the frequencies stored in the memory 30 is compared to a predetermined baseline data set 35 by the processor. The predetermined baseline data set is determined in two ways. First, by physically measuring looseness and second, with vibration tests on a bearing with an ideal known looseness state.

The preload amount by considering the amplitude of bearing and rotating speed peaks in both regular spectra and demodulated spectra are quantified. The frequencies or bands of frequencies based on machine running speed, bearing geometry and machine structure and response are measured to determine the peaks desired to be compared.

In particular, the following criteria about the peaks to be compared with respect to the rotating machine 10 may be obtained:
The numerical relationships for desired harmonic peaks at 1 times running speed or first order,
The numerical relationships for desired peaks at exact multiples of running speed,
The numerical relationships for desired peaks at 3 times running speed or synchronous peak,
The numerical relationships for running speed for desired non-synchronous peaks, and
The numerical relationships for running speeds at multiples of running speed may.

Consequently, a match between the numerical relationship for each of the frequencies and the predetermined baseline data set value indicates a correct preload has been determined by the processor.

### EXAMPLE

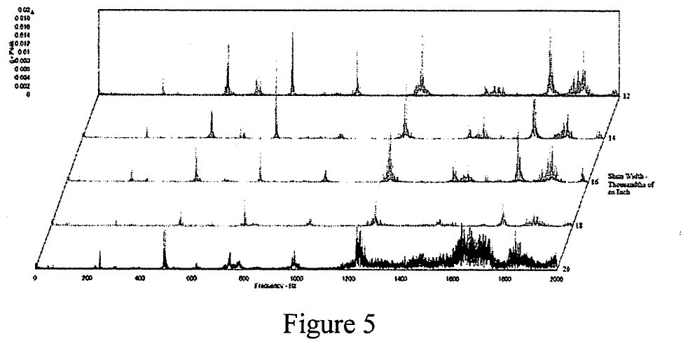

Referring to FIG. 5, an example of this system 100 and the analysis for determining a numerical relationship between for these frequencies is shown. The graph in FIG. 5 illustrates harmonic amplitudes of the bearing 15 as the width of shim 85 is increased at various rotational frequencies.

Referring still to FIG. 5, the bearing 15 with a shim 85 having a width of 12/1000ths of an inch may represent a state of “tightness” within the bearing 15. This bearing 15 may have relatively high peaks indicating various degrees of unwanted vibration. Likewise, the bearing 15 with a shim 85 having a width of 20/1000ths of an inch may represent a state of “looseness” within the bearing 15. This bearing 15 may have relatively high peaks indicating various degrees of unwanted vibration as well as much noise which makes measuring and determining a noise-floor ratio difficult. As can be seen above, bearing harmonic amplitudes decrease as the bearing is unloaded to an “ideal” condition (i.e., when the shim 85 has a width of 18/1000ths of an inch). Then the haystacks and harmonic amplitudes increase again when the bearing may be too “loose.”

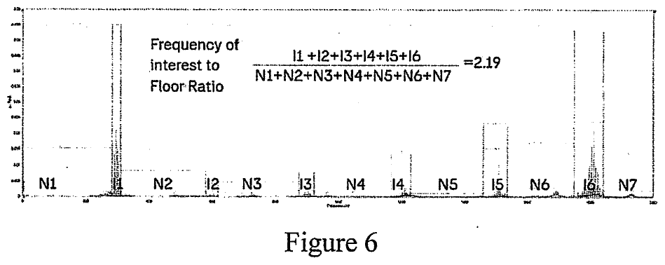

Continuing this example, two scenarios of determining a numerical relationship between various running frequencies, or “interesting” frequencies, and the noise floor, or “non-interesting” frequencies, may be disclosed. The first scenario may occur when this bearing is “tight,” or a preload exists within the bearing. FIG. 6 shows an exemplary plot with equation representing the ratio “interesting” (I) frequencies to “non-interesting” (N) frequencies.

The graph in FIG. 6 may illustrate a case where there is a preload on the bearing, or the bearing is “tight” (i.e., the bearing depicted in FIG. 5 with a shim 85 having a width of 12/1000ths of an inch). Here, it may be seen that the ratio is relatively high as compared to the next example. This means that the peak amplitudes are high compared to the amplitudes of the noise floor. In the normal operation of a bearing 15, this may indicate defects as the vibrational frequencies are high.

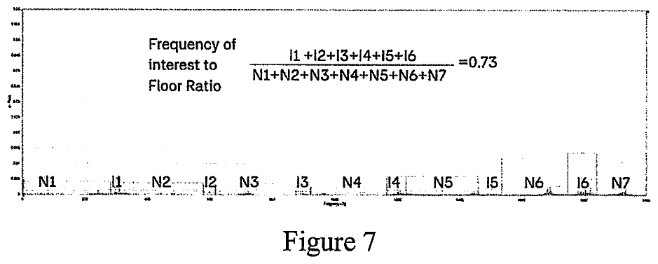

In contrast to FIG. 6, FIG. 7 may depict a bearing operating under an ideal load (i.e., the bearing depicted in FIG. 5 with a shim 85 having a width of 18/1000ths of an inch). Here, the ratio of the peak amplitudes of the “interesting” frequencies to the noise floor is relatively low. This may indicate that the bearing is running with very little or no excess vibration (i.e., the bearing is operating stably and there are no defects present).

In a non-illustrated example, the bearing that is “loose” may have a very low frequency of interest to noise floor ratio as the peaks of the floor would be very close in amplitude to the peaks of interest. This can be seen generally in FIG. 5 with haystacks of the bearing with a shim width of 20/1000ths of an inch.

Generally speaking, there exists a relationship between frequency of interest to noise floor ratio and the amount of looseness or tightness that exists within the bearing. The numerical relationship, or ratio, may be the sum of the interesting peak bands divided by the sum of the noise floor bands. The optimal ratio may 0.6 to 0.9. More preferably, the optimal ratio may be 0.7 to 0.8. METHOD

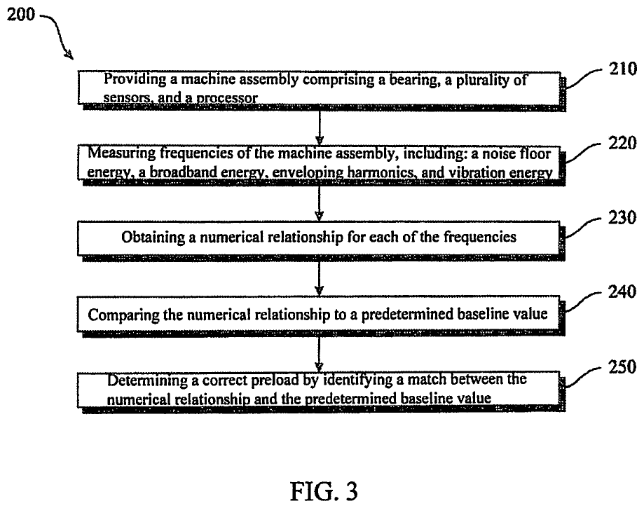

A method 200 for determining bearing preload by frequency measurement is illustrated in FIG. 3.

In a first step 210, the method comprises providing a machine assembly including a bearing, a plurality of sensors in communication with the machine assembly, and a processor in communication with the plurality of sensor.

In a second step 220, the method comprises measuring the following related frequencies of the machine assembly including the bearing with the processor; a noise floor energy, a broadband energy, enveloping harmonics, and an overall vibration energy. Here, the frequencies or bands of frequencies are measured based on machine running speed, bearing geometry and machine structure and response to determine the peaks desired to be compared.

In a third step 230, the method provides obtaining a numerical relationship for each of the related frequencies. Here, the frequencies are transformed into spectral data.

In a fourth step 240, the method provides comparing the numerical relationship for each of the related frequencies to a predetermined baseline value. The predetermined baseline values may be identified by physically measuring looseness or with vibration tests on a bearing with an ideal known looseness state.

In a fifth step 250, the method provides determining a correct preload by identifying a match between the numerical relationship for each of the related frequency and the predetermined baseline value. Here, the preload amount quantified by considering the amplitude of bearing and rotating speed peaks in both regular spectra and demodulated spectra.

Since many modifications, variations, and changes in detail can be made to the described preferred embodiments and methods of the invention, it is intended that all matters in the foregoing description and shown in the accompanying drawings be interpreted as illustrative and not in a limiting sense. Thus, the scope of the invention should be determined by the appended claims and their legal equivalence.

The present invention may be a system, a method, and/or a computer program product at any possible technical detail level of integration. The computer program product may include a computer readable storage medium (or media) having computer readable program instructions thereon for causing a processor to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One of ordinary skill in the art will appreciate from this disclosure that device elements, as well as materials, shapes and dimensions of device elements, as well as methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed, described in the specification, and/or shown in the figures. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

What is claimed is:

1. A method of determining bearing preload by frequency measurement, the method comprising the steps of:
providing a machine assembly including a bearing, a plurality of sensors in communication with the machine assembly, and a processor in communication with the plurality of sensors,
measuring the following related frequencies of the machine assembly including the bearing with the processor;
a noise floor energy,
a broadband energy,
enveloping harmonics, and
an overall vibration energy,
obtaining a numerical relationship by spectral analysis for each of the related frequencies and storing them into a memory,
comparing the numerical relationship stored in memory for each of the related frequencies to a predetermined baseline value, wherein
a match between the numerical relationship for each of the stored frequency and the predetermined baseline value indicates a correct preload has been determined.

2. The method according to claim 1, wherein the numerical relationship is a ratio calculated by dividing a sum of a plurality of broadband energies across a spectrum of rotational frequencies by a sum of a plurality of noise floor energies across the spectrum of rotational frequencies.

3. The method according to claim 1, further comprising determining the predetermined baseline value by physically measuring looseness or with vibration tests on a bearing with an ideal known looseness state.

4. The method according to claim 1, further comprising measuring the frequencies or bands of frequencies based on machine running speed, bearing geometry and machine structure and response to determine the peaks desired to be compared.

5. The method according to claim 4, further comprising obtaining numerical relationships for desired harmonic peaks at 1 times running speed or first order.

6. The method according to claim 4, further comprising obtaining numerical relationships for desired peaks at exact multiples of running speed.

7. The method according to claim 4, further comprising obtaining numerical relationships for desired peaks at 3 times running speed or synchronous peak.

8. The method according to claim 4, further comprising obtaining numerical relationships for running speed for desired non-synchronous peaks.

9. The method according to claim 8, further comprising obtaining numerical relationships for running speeds at multiples of running speed.

10. The method according to claim 4, further comprising quantifying the preload amount by considering the amplitude of bearing and rotating speed peaks in both regular spectra and demodulated spectra.

11. A system for determining bearing preload by frequency measurement, the system comprises:
a machine assembly including a bearing,
a plurality of sensors in communication with the machine assembly,
a processor in communication with the plurality of sensors, wherein frequencies of the machine assembly including the bearing are measured with the processor, which include a noise floor energy, a broadband energy, enveloping harmonics, and an overall vibration energy,
a numerical relationship for each of the related frequencies is obtained by the processor through spectral analysis, wherein
the numerical relationship for each of the related frequencies is compared to a predetermined baseline value by the processor, and wherein
a match between the numerical relationship for each of the related frequency and predetermined baseline value indicates a correct preload has been determined by the processor.

12. The system according to claim 11, wherein the sensor is at least one of a laser vibrometer, an accelerometer and/or a coil vibrometer.

13. The system according to claim 11, wherein the predetermined baseline value is determined by physically measuring looseness or with vibration tests on a bearing with an ideal known looseness state.

14. The system according to claim 11, wherein the frequencies or bands of frequencies based on machine running speed, bearing geometry and machine structure and response are measured to determine the peaks desired to be compared.

15. The system according to claim 14, wherein relationships for desired harmonic peaks at 1 times running speed or first order are obtained.

16. The system according to claim 14, wherein numerical relationships for desired peaks at exact multiples of running speed are obtained.

17. The system according to claim 14, wherein numerical relationships for desired peaks at 3 times running speed or synchronous peak are obtained.

18. The system according to claim 14, wherein numerical relationships for running speed for desired non-synchronous peaks are obtained.

19. The system according to claim 18, wherein numerical relationships for running speeds at multiples of running speed are obtained.

20. The system according to claim 14, wherein the preload amount by considering the amplitude of bearing and rotating speed peaks in both regular spectra and demodulated spectra are quantified.
